(19) United States
(12) Patent Application Publication
(10) Pub. No.: US 2016/0191678 A1
(43) Pub. Date: Jun. 30, 2016

(54) TECHNOLOGIES FOR DATA INTEGRITY OF MULTI-NETWORK PACKET OPERATIONS

(71) Applicants: Jesse C. Brandeburg, Portland, OR (US); Scott P. Dubal, Beaverton, OR (US); Patrick Connor, Beaverton, OR (US); James R. Hearn, Hillsboro, OR (US)

(72) Inventors: Jesse C. Brandeburg, Portland, OR (US); Scott P. Dubal, Beaverton, OR (US); Patrick Connor, Beaverton, OR (US); James R. Hearn, Hillsboro, OR (US)

(21) Appl. No.: 14/583,660

(22) Filed: Dec. 27, 2014

(51) Int. Cl. H04L 29/06; H04L 12/743

(52) U.S. Cl. CPC H04L 69/161; H04L 45/7453; H04L 69/166; H04L 69/22

(57) ABSTRACT

Technologies for ensuring data integrity for multi-packet operations include a computing device and a remote computing device communicatively coupled via a network. The computing device is configured to perform a segmentation offload operation on an original network packet, compute a hash value on the payload of each segmented payload of the original network packet, and store the hash value and an indication into the segmented network packet that indicates the hash value is stored in the segmented network packet. The remote computing device is configured to extract the indication and the hash value from a received network packet in response to determining the indication indicates the hash value is stored in the segmented network packet, compute a hash value on the payload of received network packet, and determine an integrity of the payload based on a comparison of the extracted hash value and the computed hash value.

### BACKGROUND

Modern computing devices have become ubiquitous tools for personal, business, and social uses. As such, many modern computing devices are capable of connecting to various data networks, including the Internet and corporate intranets, to retrieve and transmit/receive data communications over such networks. To facilitate communications between computing devices, networks typically include one or more network devices (e.g., network switches, network routers, servers, other compute and/or store computing devices, etc.) to route communications (i.e., network packets) from a source computing device to a destination computing device. As a network packet is processed by each network device in its path (i.e., network flow), a probability of the network packet becoming corrupted, or errors introduced into the network packet, increases with each network device that processes the network packet. For example, hardware offload operations, such as segmentation offload, checksum offload, and the like, that may be performed at the source computing device and/or at any of the network devices may introduce data corruption or other data integrity issues.

Present methods to detect errors in the network packet are designed to detect network packet errors at certain layers of the Open Systems Interconnection (OSI) model. For example, cyclic redundancy checks performed at the physical layer of the OSI model, are calculated after the hardware offload operations modify the network packet during a transmit operation. As such, the cyclic redundancy checks will likely not catch errors introduced by the hardware offload operations themselves, because the hardware offload operations are performed at layers above the data link layer of the OSI model. In certain network topologies, such as those network topologies wherein data integrity of the network packets are given a higher priority than latency associated with processing the network packets across the network, errors introduced into the network packet from hardware offload operations may be especially problematic.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for ensuring data integrity of network communications;

FIG. 2 is a simplified block diagram of at least one embodiment of a computing device of the system of FIG. 1;

FIG. 3 is a simplified block diagram of at least one embodiment of a network device of the system of FIG. 1;

FIG. 4 is a simplified block diagram of at least one embodiment of an environment that may be established by a computing device of FIG. 2 and a remote computing device of FIG. 3;

FIG. 5 is a simplified flow diagram of at least one embodiment of a method for storing a data integrity check into a network packet for transmission in the system of FIG. 1 that may be executed by a computing device of FIG. 2 or a remote computing device of FIG. 3; and

FIG. 6 is a simplified flow diagram of at least one embodiment of a method for performing a data integrity check of a received network packet in the system of FIG. 1 that may be executed by a computing device of FIG. 2 and a remote computing device of FIG. 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

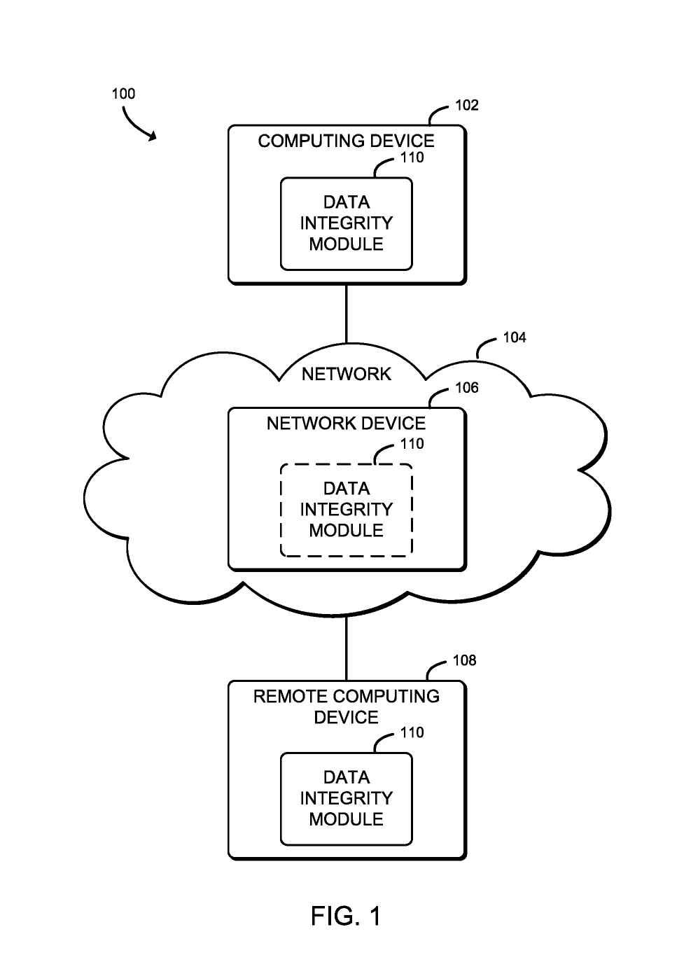

Referring now to FIG. 1, in an illustrative embodiment, a system 100 for ensuring data integrity (i.e., maintaining and assuring the accuracy and consistency) of network communications includes a computing device 102 and a remote computing device 108 in communication over a network 104 via one or more network devices 106. The network devices 106 facilitate network communications (i.e., network packets) between the computing device 102 and the remote computing device 108 over the network 104. For example, the computing device 102 may request data from the remote computing device 108 by sending a network packet that includes the request. Of course, it should be appreciated that the request may be sent via more than one network packet. In response to the request, the remote computing device 108 may attempt to transmit data (i.e., a payload) via one or more network packets to the computing device 102 across the network 104. In some embodiments, the remote computing device 108 may generate an original network packet (i.e., an unsegmented network packet) including all the data in the response, which may result in the original network packet having a large payload. However, the original network packet may include so much data that transmitting the data as a single network packet might put a strain on the network devices 106 responsible for processing and transmitting the network packet. For example, such a large payload might be network intensive, causing a decrease in bandwidth throughput and an increase processor overhead. In some embodiments, hardware of the computing device 108 may be enabled to perform a hardware offload, such as a segmentation offload. As such, the original payload of the original network packet may be broken down into segments (i.e., segmented network packets with smaller payload), which should be more manageable for the network devices to process. However, such hardware offloading (i.e., network packet segmenting) may introduce errors into one or more of the segmented network packets.

In use, as described in further detail below, a data integrity module 110 of the remote computing device 108 computes a hash value of each payload of the segmented network packets and updates a network packet header corresponding to each payload with the hash value prior to transmitting the network packet to the computing device 102 via the network 104. Of course, to ensure additional processing of the network packet does not cause a corruption, the hash value may be computed on the payload as soon as the segments are created (e.g., before a header is attached to the segmented payload). Additionally, in some embodiments, the hash value may be computed using a cryptographic hash function, such as a message digest function (e.g., MD4, MDS, etc.), a secure hash algorithm (e.g., SHA-2, SHA-3, etc.), a message authentication code (MAC) (e.g., cryptographic MAC, keyed-hash MAC, etc.), and the like.

Upon receiving one of the segmented network packets at the computing device 102, a data integrity module 110 of the computing device 102 extracts the hash value from the header of the segmented network packet and, like the remote computing device 108, also computes a hash value of the payload of the segmented network packet. Of course, it should be appreciated that the hash function used by the data integrity module 110 of the computing device 102 should be the same hash function used by the data integrity module 110 of the remote computing device 108. Additionally, in an embodiment wherein the hash value is computed over more than one segment of the segmented network packets by the data integrity module 110 of the remote computing device 108, the hash value computed by the data integrity module 110 of the computing device 102 should be computed over the same segments of the received segmented network packets. Accordingly, the data integrity module 110 of the computing device 102 may compare the extracted hash value with the computed hash value to determine whether the payload of the segmented network packet may have been corrupted, or errors introduced into the segmented network packet, during transmission and/or processing of the network packet.

In some embodiments, the data integrity module 110 of the remote computing device 108 computes a hash value of the original payload of the original network packet. In such embodiments, the data integrity module 110 updates a header of the last segmented network packet in the sequence of segmented network packets prior to transmitting the network packet to the computing device 102 via the network 104. In such an embodiment, the data integrity module 110 of the computing device 102 may only compute a hash value after the last segmented network packet in the sequence of segmented network packets is received by the computing device 102. Accordingly, the data integrity module 110 of the computing device 102 extracts the hash value from the header of the last segmented network packet and computes the hash value after the computing device 102 reconstructs the single payload from the segmented payloads. As such, the integrity of the original payload may be checked to ensure the hardware offload did not introduce any errors during the segmentation of the original payload.

The network 104 may be embodied as any type of wired or wireless communication network, including cellular networks (e.g., Global System for Mobile Communications (GSM)), digital subscriber line (DSL) networks, cable networks, telephony networks, local or wide area networks, global networks (e.g., the Internet), or any combination thereof. The network devices 106 may be embodied as any type of computing device capable of facilitating wired and/or wireless network communications between the computing device 102 and the remote computing device 108. For example, the network devices 106 may be embodied as computers, routers, switches, network hubs, servers, storage devices, compute devices, etc. Additionally, the network 104 may include any number of network devices 106 as needed to facilitate communication between the computing device 102 and the remote computing device 108 through the network devices 106 of the network 104. In some embodiments, the network device 106 may include the data integrity module 110 additionally or alternatively to the computing device 102 and/or the remote computing device 108.

The data integrity module 110 may be embodied as hardware, firmware, software, or a combination thereof. For example, in some embodiments, the data integrity module 110 may be embodied as a special purpose circuit for performing the functions described herein. In use, as will be described in more detail below, the data integrity module 110 may be located in the computing device 102 and the remote computing device 108. Of course, in some embodiments, only a portion of the data integrity module 110 may be located in the computing device 102 and the remote computing device 108. For example, in some embodiments, the remote computing device 108 may only include portions of the data integrity module 110 that update the network packet header and further process the network packet for transmission to the computing device 102, while the computing device 102 may only include portions of the data integrity module 110 that compute the hash value and further verify the integrity of the network packet received from the remote computing device 108.

The remote computing device 108 may be embodied as any type of computation or computer device capable of performing the functions described herein, including, without limitation, a computer, a smartphone, a tablet computer, a laptop computer, a notebook computer, a mobile computing device, a wearable computing device, a multiprocessor system, a server (e.g., stand-alone, rack-mounted, blade, etc.), a network appliance (e.g., physical or virtual), a web appliance, a distributed computing system, a processor-based system, and/or a consumer electronic device. In use, the remote computing device 108 is configured to communicate with the computing device 102 over the network 104 via the network devices 106. As discussed previously and shown in FIG. 1, at least a portion of the data integrity module 110 may be included in the remote computing device 108.

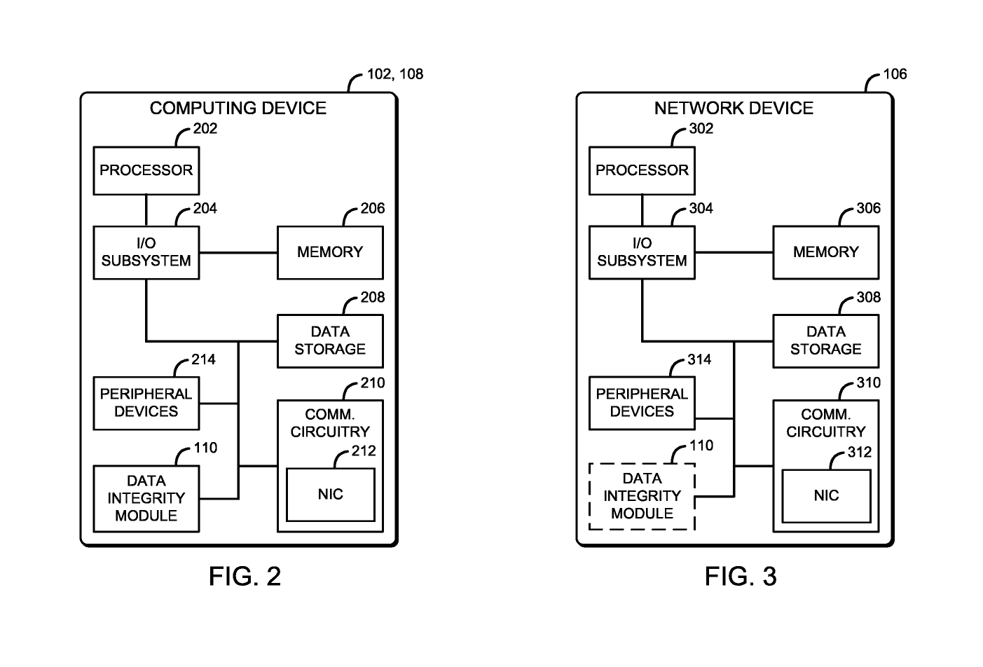

The computing device 102 may be embodied as any type of computation or computer device capable of performing the functions described herein, including, without limitation, a computer, a desktop computer, a workstation, a laptop computer, a notebook computer, a tablet computer, a mobile computing device, a wearable computing device, a network appliance, a web appliance, a distributed computing system, a processor-based system, and/or a consumer electronic device. As shown in FIG. 2, an illustrative computing device 102 includes a processor 202, an input/output (I/O) subsystem 204, a memory 206, a data storage device 208, communication circuitry 210, and peripheral devices 214. Of course, the computing device 102 may include other or additional components, such as those commonly found in a desktop computer (e.g., various input/output devices), in other embodiments. Additionally, in some embodiments, one or more of the illustrative components may be incorporated in, or otherwise form a portion of, another component. For example, the memory 206, or portions thereof, may be incorporated in one or more processors 202 in some embodiments. Further, as described previously, the data integrity module 110 may be located in the computing device 102 and the remote computing device 108. As such, the remote computing device 108 may include like components to the illustrative computing device 102, which are not illustrated herein to preserve clarity of the description with the understanding that the description of the like components provided below in regard to the computing device 102 of FIG. 2 applies equally to the like components of the remote computing device 108.

The processor 202 may be embodied as any type of processor capable of performing the functions described herein. The processor 202 may be embodied as a single or multi-core processor(s), digital signal processor, microcontroller, or other processor or processing/controlling circuit. The memory 206 may be embodied as any type of volatile or non-volatile memory or data storage capable of performing the functions described herein. In operation, the memory 206 may store various data and software used during operation of the computing device 102 such as operating systems, applications, programs, libraries, and drivers. The memory 206 is communicatively coupled to the processor 202 via the I/O subsystem 204, which may be embodied as circuitry and/or components to facilitate input/output operations with the processor 202, the memory 206, and other components of the computing device 102. For example, the I/O subsystem 204 may be embodied as, or otherwise include, memory controller hubs, input/output control hubs, integrated sensor hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 204 may form a portion of a system-on-a-chip (SoC) and be incorporated, along with the processors 202, the memory 206, and other components of the computing device 102, on a single integrated circuit chip.

The data storage device 208 may be embodied as any type of device or devices configured for short-term or long-term storage of data such as, for example, memory devices and circuits, memory cards, hard disk drives, solid-state drives, or other data storage devices. In some embodiments, the data storage device 208 may be used to store the contents of one or more trusted execution environments. When stored by the data storage device 208, the contents of the trusted execution environments may be encrypted to prevent access by unauthorized software.

The communication circuitry 210 may be embodied as any communication circuit, device, or collection thereof, capable of enabling communications between the computing device 102 and the remote computing device 108 over the network 104. The communication circuitry 210 may be configured to use any one or more communication technology (e.g., wired or wireless communications) and associated protocols (e.g., Ethernet, Bluetooth®, Wi-Fi®, WiMAX, etc.) to effect such communication. The illustrative computing device 102 additionally includes a network interface card (NIC) 212. The NIC 212 may connect the computing device 102 to a network device 106. The NIC 212 may be embodied as one or more add-in-boards, daughtercards, network interface cards, controller chips, chipsets, or other devices that may be used by the network device 106. For example, the NIC 212 may be embodied as an expansion card coupled to the I/O subsystem 204 over an expansion bus, such as PCI Express. The NIC 212 may be configured to perform hardware offload operations, such as segmentation offload, checksum offload, and/or other hardware offload operations. For example, in an embodiment wherein the NIC 212 supports segmentation offload, the NIC 212 may determine an original network packet (i.e., an unsegmented network packet) with an original payload is too large to send as a single packet. As such, the NIC 212 segments the original payload of the original network packet into multiple segmented network packets with smaller payloads. As a result of the segmentation, the segmentation may result in increased bandwidth throughput of the communication circuitry 210 and reduced overhead of the processor 202.

The one or more peripheral devices 214 may include any type of peripheral device commonly found in a computing device, such as a hardware keyboard, input/output devices, peripheral communication devices, and/or the like, for example. Additionally or alternatively, the peripheral devices 214 may include one or more ports for connecting external peripheral devices to the computing device 102, such as USB, for example.

Referring now to FIG. 3, the network device 106 may be embodied as any type of computing device capable of facilitating wireless network communications between the computing device 102 and the remote computing device 108, and performing the functions described herein. For example, the network device 106 may be embodied as a virtual and/or physical network device, such as, without limitation, an access point, a router, a server, a network hub, a compute device, a storage device, etc. Similar to the computing device 102 illustrated in FIG. 2, an illustrative network device 106 includes a processor 302, an input/output (I/O) subsystem 304, a memory 306, a data storage device 308, communication circuitry 310 including a NIC 312, and one or more peripheral devices 314. As such, further descriptions of the like components are not repeated herein for clarity of the description with the understanding that the description of the corresponding components provided above in regard to the computing device 102 of FIG. 2 applies equally to the corresponding components of the network device 106 of FIG. 3. Of course, in other embodiments, the network device 106 may include other or additional components, such as those commonly found in a network device.

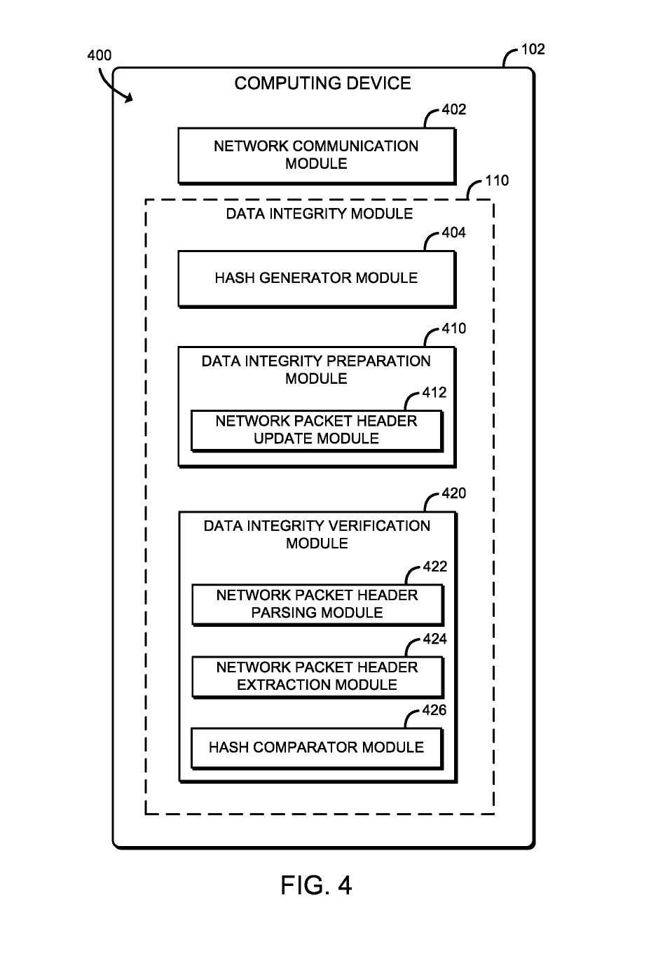

Referring now to FIG. 4, the computing devices 102, 108 establish an environment 400 during operation. In the illustrative environment 400, the computing device 102 includes a network communication module 402, a hash generator module 408, a data integrity preparation module 410, and a data integrity verification module 420. The various modules of the environment 400 may be embodied as hardware, firmware, software, or a combination thereof. For example, the various modules, logic, and other components of the environment 400 may form a portion of, or otherwise be established by, the processor 202 or other hardware components of the computing device 102 or the remote computing device 108. As such, in some embodiments, any one or more of the modules of the environment 400 may be embodied as a circuit or collection of electrical devices (e.g., a hash generator circuit, a data integrity preparation circuit, a data integrity verification circuit, etc.). In some embodiments, during operation, the data integrity module 110 may establish one or more of the modules (e.g., the hash generator module 408, the data integrity preparation module 410, and/or the data integrity verification module 420) of the illustrative environment 400. Additionally, in some embodiments, one or more of the illustrative modules may form a portion of another module and/or one or more of the illustrative modules may be embodied as a standalone or independent module.

The network communication module 402 is configured to facilitate network communications between the computing device 102 and the network devices 106. In other words, the network communication module 402 is configured to receive and process network packets received by the computing device 102 and to prepare and transmit network packets from the computing device 102. Additionally, the network communication module 402 may be configured to perform hardware offload operations, such as segmentation offload. In such a configuration, the network communication module 402 may break up an original network packet (i.e., an unsegmented network packet) with an original payload that is too large to be received by a requesting computing device. To do so, the network communication module 402 may perform a segmentation offload by breaking up the original network packet (i.e., the original payload) into multiple network packets (i.e., segments) with smaller payloads. The network communication module 402 based the segmented payload size based on a maximum payload size provided by the requesting computing device, indicating the maximum payload size the requesting computing device can support. For example, in a TCP session, the requesting computing device typically informs a host computing device of a TCP receive window size (i.e., a maximum amount of information that a machine can receive during a TCP session). Of course, due to a buffer of the requesting computing device processing the received segmented network packets, the maximum payload size the requesting computing device can support may change as available space in the buffer changes. In such an embodiment, the computing device 102 (i.e., the initiating computing device) may inform the remote computing device 108 (i.e., the host computing device) of a TCP receive window size that is smaller than the network packet with the large payload. As such, a network communication module 402 of the remote computing device 108 may break up the network packet with the payload larger than the TCP receive window size into a flow of segmented network packets, each with a smaller payload than the TCP receive window size. Additionally, the network communication module 402 may process a received network packet by parsing the network packet header to determine network flow information (a source port, a destination port, etc.) of the received network packet and/or prepare a network packet for transmission by storing network flow information into the header of the network packet.

The hash generator module 408 is configured to compute a hash value of a payload of a network packet using a hash function. In some embodiments, the hash generator module 408 may compute the hash value of the entire segmented payload. In other embodiments, the hash value may be computed of just a portion of the segmented payload. In alternative embodiments, the hash value may be computed over more than one payload of the segmented payloads, or flow. In some embodiments, the hash function may be a cryptographic hash function, such as a message digest function (e.g., MD4, MDS, etc.), a secure hash algorithm (e.g., SHA-2, SHA-3, etc.), a message authentication code (MAC) (e.g., cryptographic MAC, keyed-hash MAC, etc.), and the like. Of course, the type of hash function and the payload (i.e., original payload and/or each segmented payload) on which the hash value is computed, needs to be consistent between the source computing device, the target computing device, and any network devices 106 between the source and target computing devices using the hash function.

The data integrity preparation module 410 is configured to store the hash value within a segmented network packet to be transmitted and provide an indication that the hash value is stored in the segmented network packet so that a data integrity check may be performed on the segmented network packet by a receiving computing device, such as the remote computing device 108. The data integrity preparation module 410 includes a network packet header update module 412. The network packet header update module 412 is configured to update the segmented network packet by storing the hash value in a portion of a header of the segmented network packet and provide a data integrity check indication in another portion of the segmented network packet header, indicating to perform a data integrity verification on the segmented network packet at a destination computing device. In an embodiment wherein the segmented network packet is a TCP packet, the network packet header update module 412 may be configured to store the hash value in an options field and set a reserved bit of the header of the TCP packet to indicate to perform the data integrity verification on the segmented network packet at the destination computing device. Of course, in other embodiments, the network packet header update module 412 may provide an alternative indication and/or store the hash value in an available (i.e., unused) header field of a segmented network packet of a different type, such as the optional device header field of a fibre channel (FC) frame.

The data integrity verification module 420 is configured to verify data integrity of a received network packet. For example, the data integrity verification module 420 may be configured to check the hash value stored in the received network packet to verify the data integrity of the received network packet. The data integrity verification module 420 includes a network packet header parsing module 422, a hash extraction module 424, and a hash comparator module 426. The network packet header parsing module 422 is configured to parse the header of the received network packet. In some embodiments, the header of the received network packet may be parsed by the network communication module 402.

The hash extraction module 424 is configured to extract the data integrity check indicator from a header the received network packet and extract the hash value subsequent to the data integrity check indicator indicating that the hash value is stored in the network packet header. In some embodiments, the hash extraction module 424 may be configured to extract the hash value and/or the data integrity check indicator from the header of the received network packet. For example, in a TCP header of a TCP packet, the hash extraction module 424 may be configured to extract the hash value from an options field of the header of the TCP packet and/or the data integrity check indicator from a reserved bit. The hash comparator module 426 is configured to perform a data integrity check by comparing the extracted hash value with a hash value of the payload of the received network packet. In some embodiments, the hash may be computed by the hash generator module 404. The hash comparator module 426 may be further configured to provide an indication of the data integrity of the network packet based on the comparison. For example, if a comparison by the hash comparator module 426 indicates the extracted hash value and the computed hash value do not match, the hash comparator module 426 may provide an indication to a component of the computing device 102, such as the communication circuitry 210, indicating the received network packet has been corrupted and that a new packet should be requested.

It should be appreciated that the computing device 102 and/or the remote computing device 108 may only include a portion of the illustrative environment 400. For example, in some embodiments, the computing device 102 may include the data integrity verification module 420, while the remote computing device 108 may include the data integrity preparation module 410.

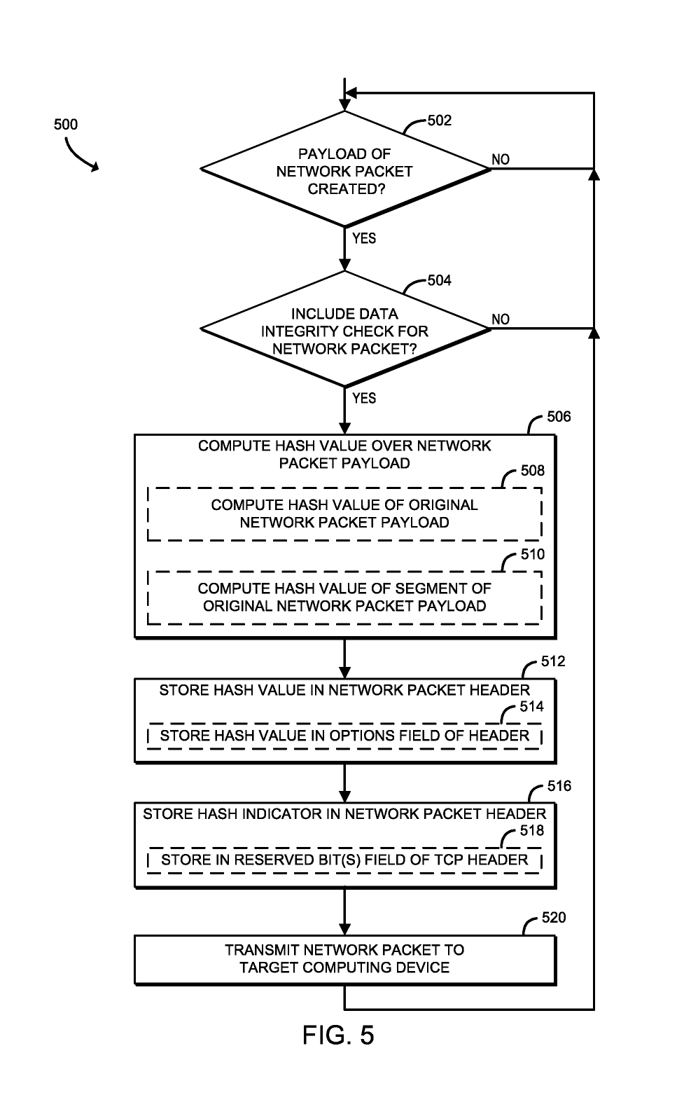

Referring now to FIG. 5, in use, the remote computing device 108 may execute a method 500 for storing a data integrity check into a network packet for transmission in the system 100. Of course, if the computing device 102 is the computing device preparing the network packet for transmission, the operations of the method 500 described herein may be performed by the computing device 102. It should be appreciated that, in some embodiments, one or more operations performed in the method 500 may be executed by the data integrity module 110.

The illustrative method 500 begins at block 502, in which the remote computing device 108 determines whether a payload of a network packet has been created. In some embodiments, the method 500 may be initialized (i.e., started) upon receipt of a notification that a payload of a network packet has been created, as opposed to employing a polling method (i.e., sampling at predetermined time intervals to determine whether a payload of a segmented network packet has been created). In use, in some embodiments, the remote computing device 108 may create a single network packet with a payload too large to be efficiently processed across the network 104. In other words, the payload size of the single network packet may be greater than a maximum allowable payload size (e.g., TCP receive window size) for a destination computing device (e.g., the computing device 102). The remote computing device 108 may rely on a hardware component, such as a NIC, to perform a hardware offload, such as a segmentation offload, to divide the single network packet with the large payload into a flow of more than one network packet segments with smaller payloads that do not exceed the maximum allowable payload size. As described previously, in some embodiments, the hash value may be computed from the original payload and/or from each segmented payload. As such, the remote computing device 108 may determine whether a payload of the original network packet has been created and/or whether a segmented payload of the original network packet has been created (i.e., segmented). If the payload of the network packet has not been created, the method 500 loops back to block 502 to continue to determine whether a payload of a network packet has been created; otherwise, the method advances to block 504.

In block 504, the remote computing device 108 determines whether to include a data integrity check for the payload of the network packet. If not, the method 500 loops back to block 502 to continue to determine whether a payload has been created. If the remote computing device 108 determines to include the data integrity check for the payload of the network packet, the method advances to block 506.

In block 506, the remote computing device 108 computes a hash value of the payload of the network packet. In some embodiments, in block 508, the hash value may be computed over the original network packet payload. Additionally or alternatively, in block 510, in some embodiments, the hash value may be computed over each of the segmented network packet payloads. In some embodiments, the hash value may be computed over two or more payloads of the flow of segmented network packets. In some embodiments, the hash value may be a cryptographic hash function, such as a message digest function (e.g., MD4, MD5, etc.), a secure hash algorithm (e.g., SHA-2, SHA-3, etc.), a message authentication code (MAC) (e.g., cryptographic MAC, keyed-hash MAC, etc.), and the like.

In block 512, the remote computing device 108 stores the computed hash value in a header of the network packet. As described above, if the hash value is of the original payload, the hash value may be stored in the header of the last segmented network packet in the flow of segmented network packets. In some embodiments, wherein the network packet is a TCP packet, the remote computing device 108 may store the hash value in an options field of the TCP packet header in block 514. In block 516, the remote computing device 108 stores an indication (i.e., a data integrity check indication) in the network packet header that indicates the hash value is stored in the network packet header. As described above, if the hash value is of the original payload, the data integrity check indication may be stored in the header of the last segmented network packet in the flow of segmented network packets. In some embodiments, wherein the network packet is a TCP packet, the remote computing device 108 may set a reserved bit of the header of the TCP packet to indicate that the hash value is included in block 518. In block 520, the remote computing device 108 transmits the network packet to a target computing device (e.g., the network device 106) before looping back to block 502 to continue to determine whether a payload of another network packet has been created.

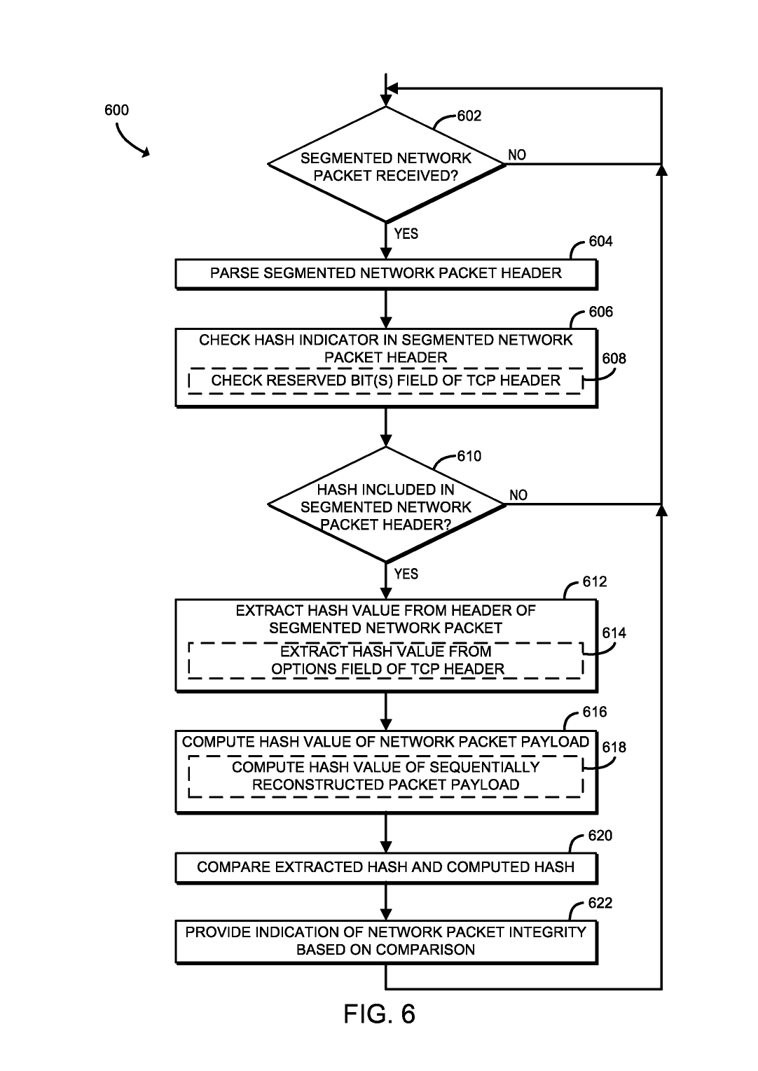

Referring now to FIG. 6, in use, the computing device 102 may execute a method 500 for performing a data integrity check of a received segmented network packet to ensure data integrity of network communications in the system 100. Of course, if the remote computing device 108 is the computing device receiving the segmented network packet, the operations of the method 600 described herein may be performed by the remote computing device 108. It should be appreciated that, in some embodiments, one or more operations performed in the method 600 may be executed by the data integrity module 110. The illustrative method 600 begins at block 602, in which the computing device 102 determines whether a segmented network packet has been received. In some embodiments, the method 600 may be initialized (i.e., started) upon receipt of the segmented network packet, as opposed to employing a polling method (i.e., sampling at predetermined time intervals to determine whether a network packet was received). If the computing device 102 determines a segmented network packet has not been received, the method 600 loops back to block 602 to continue to determine whether a segmented network packet has been received.

If the computing device 102 determines a segmented network packet has been received, the method 600 advances to block 604, wherein the computing device 102 parses a header of the segmented network packet. In an embodiment wherein the hash value was computed of the original payload, the method may not advance to block 604 until the last segmented network packet of the flow of segmented network packets has been received, as only the header of the last segmented network packet may include the hash value necessary to perform the operations of method 600. In block 606, the computing device 102 checks for an indicator of the stored hash value (i.e., a hash indicator) in the segmented network packet header. In an embodiment wherein the network packet is a TCP packet, the computing device 102 may determine whether the hash indicator is included by detecting whether a particular reserved bit of the TCP packet header has been set in block 608.

In block 610, the computing device 102 determines whether the hash value is stored in the segmented network packet based on the hash indicator check in block 606. If not, the method 600 loops back to block 602 to determine whether a segmented network packet has been received. If the computing device 102 determines the hash value is stored in the segmented network packet header, the method 600 advances to block 612, wherein the computing device 102 extracts the hash value from the segmented network packet header. In an embodiment wherein the network packet is a TCP packet, the computing device 102 may extract the hash value from an options field of the TCP packet header in block 614. Of course, it should be appreciated than any header field available for any type of network packet may be used to store the hash value. As such, the computing device 102 may extract the hash value from any available field for any type of network packet used to store the hash value.

In block 616, the computing device 102 computes a hash value of a payload of the segmented network packet using a hash function. In some embodiments, the remote computing device 108 may have computed the hash value of the original network packet payload. As such, the hash value may not be computed by the computing device 102, in block 618, until all of the segmented network packets have been received and sequentially reconstructed by the computing device 102. In some embodiments, the hash function may be a cryptographic hash function, such as a message digest function (e.g., MD4, MDS, etc.), a secure hash algorithm (e.g., SHA-2, SHA-3, etc.), a message authentication code (MAC) (e.g., cryptographic MAC, keyed-hash MAC, etc.), and the like. Of course, it should be appreciated that the type of hash function used to compute the hash value and the payload hashed (i.e., the original payload and/or each segmented payload) by the computing device 102 should be the same type of hash function and payload hashed at the source computing device (e.g., the remote computing device 108).

In block 620, the computing device 102 compares the extracted hash value to the computed hash value to determine whether the integrity of the payload was compromised during hardware offload and/or transmission. In block 622, the computing device 102 provides an indication of the data integrity of the network packet (e.g., corrupted or not corrupted) based on the comparison of the extracted hash value and the computed hash value. For example, if a comparison indicates the extracted hash value and the computed hash value do not match, the indication may be provided to the source computing device, such as the remote computing device 108. In an embodiment wherein the data integrity module 110 provides the indication, the indication may be sent to a component of the computing device 102, such as the communication circuitry 210, indicating the received network packet is corrupt and that a new network packet should be requested from the source computing device (i.e., a re-send request sent to the source computing device).

### EXAMPLES

Illustrative examples of the technologies disclosed herein are provided below. An embodiment of the technologies may include any one or more, and any combination of, the examples described below.

Example 1 includes a computing device to store a data integrity check into network communication transmissions, the computing device comprising a hash generator module to compute a hash value of a payload of a network packet, wherein the payload of the network packet is a result of a segmentation operation; a data integrity preparation module to store the hash value in the network packet and store an indication in the network packet to indicate to a recipient of the network packet that the hash value is stored in the network packet; and a network communication module to transmit the network packet to a remote computing device.

Example 2 includes the subject matter of Example 1, and wherein to compute the hash value of the payload comprises to compute a cryptographic hash value of the payload based on a cryptographic hash function.

Example 3 includes the subject matter of any of Examples 1 and 2, and wherein to compute the hash value of the payload comprises to compute the hash value of a plurality of payloads, and wherein the plurality of payloads are a result of the segmentation operation.

Example 4 includes the subject matter of any of Examples 1-3, and wherein to compute the hash value of the payload comprises to compute the hash value of the payload subsequent to the segmentation operation and prior to other processing of the network packet by the computing device.

Example 5 includes the subject matter of any of Examples 1-4, and wherein to store the hash value in the network packet comprises to store the hash value in a field of a header of the network packet.

Example 6 includes the subject matter of any of Examples 1-5, and wherein to store the hash value in the field of the header of the network packet comprises to store the hash value in an options field of a TCP header of the network packet.

Example 7 includes the subject matter of any of Examples 1-6, and wherein to store the indication to indicate to the recipient of the network packet that the hash value is stored in the network packet comprises to store the indication in a field of a header of the network packet.

Example 8 includes the subject matter of any of Examples 1-7, and wherein to store the indication in the field of the header of the network packet comprises to set a bit in a reserved field of a TCP header of the network packet that corresponds to the indication.

Example 9 includes the subject matter of any of Examples 1-8, and further including a data integrity module, wherein the data integrity module comprises the hash generator module and the data integrity preparation module.

Example 10 includes the subject matter of any of Examples 1-9, and wherein the network communication module is further to perform the segmentation operation on an original payload of a unsegmented network packet.

Example 11 includes a computing device to perform a data integrity check of received network communications, the computing device comprising a data integrity verification module to determine whether a first hash value is stored in a network packet received from a remote computing device and extract the first hash value from the network packet in response to a determination that the first hash value is stored in the network packet, wherein the network packet received from the remote computing device is a segmented network packet that resulted from a segmentation operation; a hash generator module to compute a second hash value of a payload of a received network packet; and a hash comparator module to compare the first hash value and the second hash value.

Example 12 includes the subject matter of Example 11, and wherein to compute the second hash value of the payload of the network packet comprises to compute a cryptographic hash value of the payload based on a cryptographic hash function.

Example 13 includes the subject matter of any of Examples 11 and 12, and wherein to compute the second hash value of the payload of the network packet comprises to compute the second hash value of a plurality of payloads, and wherein the plurality of payloads are a result of the segmentation operation.

Example 14 includes the subject matter of any of Examples 11-13, and wherein to extract the first hash value in the network packet comprises to extract the first hash value from a field of a header of the network packet.

Example 15 includes the subject matter of any of Examples 11-14, and wherein to extract the first hash value in the field of the header of the network packet comprises to extract the first hash value from an options field of a TCP header of the network packet.

Example 16 includes the subject matter of any of Examples 11-15, and wherein determine whether the first hash value is stored in the network packet comprises to extract an indication from a field of a header of the network packet.

Example 17 includes the subject matter of any of Examples 11-16, and wherein to extract the indication from the field of the header of the network packet comprises to extract a bit from a reserved field of a TCP header of the network packet that corresponds to the indication.

Example 18 includes the subject matter of any of Examples 11-17, and wherein the hash comparator module is further to provide an indication to the remote computing device that the received network packet is corrupt in response to a determination that the first hash value and the second hash value do not match.

Example 19 includes the subject matter of any of Examples 11-18, and further including a data integrity module, wherein the data integrity module comprises the data integrity verification module, the hash generator module, and the hash comparator module.

Example 20 includes a method for storing a data integrity check into a network packet at a computing device for transmission to a remote computing device, the method comprising performing, by the computing device, a segmentation offload operation on an original payload of an unsegmented network packet; computing, by the computing device, a hash value of a payload of the network packet, wherein the payload of the network packet is a result of the segmentation offload operation; storing, by the computing device, the hash value in the network packet; storing, by the computing device, an indication in the network packet to indicate to the remote computing device that the hash value is stored in the network packet; and transmitting, by the computing device, the network packet to the remote computing device.

Example 21 includes the subject matter of Example 20, and wherein computing the hash value of the payload comprises computing the hash value of the payload using a cryptographic hash function.

Example 22 includes the subject matter of any of Examples 20 and 21, and wherein computing the hash value of the payload of the network packet comprises computing the hash value of a plurality of payloads, and wherein the plurality of payloads are a result of the segmentation offload operation performed on the original payload of the unsegmented network packet.

Example 23 includes the subject matter of any of Examples 20-22, and wherein computing the hash value of the payload comprises computing the hash value of the payload subsequent to the segmentation offload operation and prior to other processing of the network packet by the computing device.

Example 24 includes the subject matter of any of Examples 20-23, and wherein storing the hash value in the network packet comprises storing the hash value in a field of a header of the network packet.

Example 25 includes the subject matter of any of Examples 20-24, and wherein storing the hash value in the field of the header of the network packet comprises storing the hash value in an options field of a TCP header of the network packet.

Example 26 includes the subject matter of any of Examples 20-25, and wherein storing the indication to indicate to the remote computing device that the hash value is stored in the network packet comprises storing the indication in a field of a header of the network packet.

Example 27 includes the subject matter of any of Examples 20-26, and wherein storing the indication in the field of the header of the network packet comprises setting a bit in a reserved field of a TCP header of the network packet that corresponds to the indication.

Example 28 includes a method for performing a data integrity check of a network packet received from a remote computing device, the method comprising determining, by a computing device, whether a first hash value is stored in the network packet received from the remote computing device; extracting, by the computing device, the first hash value from the network packet in response to a determination that the first hash value is stored in the network packet, wherein the network packet received from the remote computing device is a segmented network packet that resulted from a segmentation operation; computing, by the computing device, a second hash value of a payload of the network packet received from the remote computing device; and comparing, by the computing device, the first hash value and the second hash value.

Example 29 includes the subject matter of Example 28, and wherein computing the second hash value of the payload of the network packet comprises computing a cryptographic hash value of the payload of the network packet based on a cryptographic hash function.

Example 30 includes the subject matter of any of Examples 28 and 29, and wherein computing the second hash value of the payload of the network packet comprises computing the second hash value of a plurality of payloads, and wherein the plurality of payloads are a result of the segmentation operation.

Example 31 includes the subject matter of any of Examples 28-30, and wherein extracting the first hash value in the network packet comprises extracting the first hash value from a field of a header of the network packet.

Example 32 includes the subject matter of any of Examples 28-31, and wherein extracting the first hash value in the field of the header of the network packet comprises extracting the first hash value from an options field of a TCP header of the network packet.

Example 33 includes the subject matter of any of Examples 28-32, and wherein determining whether the first hash value is stored in the network packet comprises extracting an indication from a field of a header of the network packet, and wherein the indication is to indicate whether the first hash value is stored in the network packet.

Example 34 includes the subject matter of any of Examples 28-33, and wherein extracting the indication from the field of the header of the network packet comprises extracting a bit from a reserved field of a TCP header of the network packet that corresponds to the indication.

Example 35 includes the subject matter of any of Examples 28-34, and further including providing an indication to the remote computing device that the network packet received from the remote computing device is corrupt in response to a determination that the first hash value and the second hash value do not match.

Example 36 includes a computing device comprising a processor; and a memory having stored therein a plurality of instructions that when executed by the processor cause the computing device to perform the method of any of Examples 20-35.

Example 37 includes one or more machine readable storage media comprising a plurality of instructions stored thereon that in response to being executed result in a computing device performing the method of any of Examples 20-35.

Example 38 includes a computing device for storing a data integrity check into a network packet for transmission to a remote computing device, the computing device comprising means for performing a segmentation offload operation on an original payload of an unsegmented network packet; means for computing a hash value of a payload of the network packet, wherein the payload of the network packet is a result of the segmentation offload operation; means for storing the hash value in the network packet; means for storing an indication in the network packet to indicate to the remote computing device that the hash value is stored in the network packet; and means for transmitting the network packet to the remote computing device.

Example 39 includes the subject matter of Example 38, and wherein the means for computing the hash value of the payload comprises means for computing the hash value of the payload using a cryptographic hash function.

Example 40 includes the subject matter of any of Examples 38 and 39, and wherein the means for computing the hash value of the payload of the network packet comprises means for computing the hash value of a plurality of payloads, and wherein the plurality of payloads are a result of the segmentation offload operation performed on the original payload of the unsegmented network packet.

Example 41 includes the subject matter of any of Examples 38-40, and wherein the means for computing the hash value of the payload comprises means for computing the hash value of the payload subsequent to the segmentation offload operation and prior to other processing of the network packet by the computing device.

Example 42 includes the subject matter of any of Examples 38-41, and wherein the means for storing the hash value in the network packet comprises means for storing the hash value in a field of a header of the network packet.

Example 43 includes the subject matter of any of Examples 38-42, and wherein the means for storing the hash value in the field of the header of the network packet comprises means for storing the hash value in an options field of a TCP header of the network packet.

Example 44 includes the subject matter of any of Examples 38-43, and wherein the means for storing the indication to indicate to the remote computing device that the hash value is stored in the network packet comprises means for storing the indication in a field of a header of the network packet.

Example 45 includes the subject matter of any of Examples 38-44, and wherein the means for storing the indication in the field of the header of the network packet comprises means for setting a bit in a reserved field of a TCP header of the network packet that corresponds to the indication.

Example 46 includes a computing device for performing a data integrity check of a network packet received from a remote computing device, the computing device comprising means for determining whether a first hash value is stored in the network packet received from the remote computing device; means for extracting the first hash value from the network packet in response to a determination that the first hash value is stored in the network packet, wherein the network packet received from the remote computing device is a segmented network packet that resulted from a segmentation operation; means for computing a second hash value of a payload of the network packet received from the remote computing device; and means for comparing the first hash value and the second hash value.

Example 47 includes the subject matter of Example 46, and wherein the means for computing the second hash value of the payload of the network packet comprises means for computing a cryptographic hash value of the payload of the network packet based on a cryptographic hash function.

Example 48 includes the subject matter of any of Examples 46 and 47, and wherein the means for computing the second hash value of the payload of the network packet comprises means for computing the second hash value of a plurality of payloads, and wherein the plurality of payloads are a result of the segmentation operation.

Example 49 includes the subject matter of any of Examples 46-48, and wherein the means for extracting the first hash value in the network packet comprises means for extracting the first hash value from a field of a header of the network packet.

Example 50 includes the subject matter of any of Examples 46-49, and wherein the means for extracting the first hash value in the field of the header of the network packet comprises means for extracting the first hash value from an options field of a TCP header of the network packet.

Example 51 includes the subject matter of any of Examples 46-50, and wherein the means for determining whether the first hash value is stored in the network packet comprises means for extracting an indication from a field of a header of the network packet, and wherein the indication is to indicate whether the first hash value is stored in the network packet.

Example 52 includes the subject matter of any of Examples 46-51, and wherein the means for extracting the indication from the field of the header of the network packet comprises means for extracting a bit from a reserved field of a TCP header of the network packet that corresponds to the indication.

1. A computing device to store a data integrity check into network communication transmissions, the computing device comprising:
a hash generator module to compute a hash value of a payload of a network packet, wherein the payload of the network packet is a result of a segmentation operation;
a data integrity preparation module to store the hash value in the network packet and store an indication in the network packet to indicate to a recipient of the network packet that the hash value is stored in the network packet; and
a network communication module to transmit the network packet to a remote computing device.

2. The computing device of claim 1, wherein to compute the hash value of the payload comprises to compute a cryptographic hash value of the payload based on a cryptographic hash function.

3. The computing device of claim 1, wherein to store the hash value in the network packet comprises to store the hash value in a field of a header of the network packet.

4. The computing device of claim 3, wherein to store the hash value in the field of the header of the network packet comprises to store the hash value in an options field of a TCP header of the network packet.

5. The computing device of claim 1, wherein to store the indication to indicate to the recipient of the network packet that the hash value is stored in the network packet comprises to store the indication in a field of a header of the network packet.

6. The computing device of claim 5, wherein to store the indication in the field of the header of the network packet comprises to set a bit in a reserved field of a TCP header of the network packet that corresponds to the indication.

7. The computing device of claim 1, further comprising a data integrity module, wherein the data integrity module comprises the hash generator module and the data integrity preparation module.

8. A computing device to perform a data integrity check of received network communications, the computing device comprising:
a data integrity verification module to determine whether a first hash value is stored in a network packet received from a remote computing device and extract the first hash value from the network packet in response to a determination that the first hash value is stored in the network packet, wherein the network packet received from the remote computing device is a segmented network packet that resulted from a segmentation operation;
a hash generator module to compute a second hash value of a payload of a received network packet; and
a hash comparator module to compare the first hash value and the second hash value.

9. The computing device of claim 8, wherein to compute the second hash value of the payload of the network packet comprises to compute a cryptographic hash value of the payload based on a cryptographic hash function.

10. The computing device of claim 8, wherein to extract the first hash value in the network packet comprises to extract the first hash value from an options field of a TCP header of the network packet.

11. The computing device of claim 8, wherein determine whether the first hash value is stored in the network packet comprises to extract a bit from a reserved field of a TCP header of the network packet that corresponds to the indication.

12. The computing device of claim 8, wherein the hash comparator module is further to provide an indication to the remote computing device that the received network packet is corrupt in response to a determination that the first hash value and the second hash value do not match.

13. The computing device of claim 8, further comprising a data integrity module, wherein the data integrity module comprises the data integrity verification module, the hash generator module, and the hash comparator module.

14. One or more computer-readable storage media comprising a plurality of instructions stored thereon that in response to being executed cause a computing device to:
perform a segmentation offload operation on an original payload of an unsegmented network packet;
compute a hash value of a payload of a network packet, wherein the payload of the network packet is a result of the segmentation offload operation;
store the hash value in the network packet;
store an indication in the network packet to indicate to the remote computing device that the hash value is stored in the network packet; and
transmit the network packet to the remote computing device.

15. The one or more computer-readable storage media of claim 14, wherein to compute the hash value of the payload comprises to compute the hash value of the payload using a cryptographic hash function.

16. The one or more computer-readable storage media of claim 14, wherein to compute the hash value of the payload comprises to compute the hash value of the payload subsequent to the segmentation offload operation and prior to other processing of the network packet by the computing device.

17. The one or more computer-readable storage media of claim 14, wherein to store the hash value in the network packet comprises to store the hash value in a field of a header of the network packet.

18. The one or more computer-readable storage media of claim 17, wherein to store the hash value in the field of the header of the network packet comprises to store the hash value in an options field of a TCP header of the network packet.

19. The one or more computer-readable storage media of claim 14, wherein to store the indication comprises to store the indication in a field of a header of the network packet.

20. The one or more computer-readable storage media of claim 19, wherein to store the indication in the field of the header of the network packet comprises to set a bit in a reserved field of a TCP header of the network packet that corresponds to the indication.

21. One or more computer-readable storage media comprising a plurality of instructions stored thereon that in response to being executed cause a computing device to:
determine whether a first hash value is stored in a network packet received from a remote computing device;
extract the first hash value from the network packet in response to a determination that the first hash value is stored in the network packet, wherein the network packet received from the remote computing device is a segmented network packet that resulted from a segmentation operation;
compute a second hash value of a payload of the network packet received from the remote computing device; and
compare the first hash value and the second hash value.

22. The one or more computer-readable storage media of claim 21, wherein to compute the second hash value of the payload of the network packet comprises to compute a cryptographic hash value of the payload of the network packet based on a cryptographic hash function.

23. The one or more computer-readable storage media of claim 21, wherein to extract the first hash value in the network packet comprises to extract the first hash value from an options field of a TCP header of the network packet.

24. The one or more computer-readable storage media of claim 21, wherein to determine whether the first hash value is stored in the network packet comprises to extract a bit from a reserved field of a TCP header of the network packet that corresponds to the indication.

25. The one or more computer-readable storage media of claim 21, further comprising a plurality of instructions that in response to being executed cause the computing device to:
provide an indication to the remote computing device that the network packet received from the remote computing device is corrupt in response to a determination that the first hash value and the second hash value do not match.
